(19) United States
(12) Patent Application Publication
(10) Pub. No.: US 2023/0284652 A1
(43) Pub. Date: Sep. 14, 2023

(54) FIBER-SPUN, CHICKEN-LIKE, FOOD PRODUCTS AND METHODS FOR MANUFACTURING

(71) Applicant: Simulate, Inc., New York, NY (US)

(72) Inventors: Amir Farnoud, San Mateo, CA (US); Sean Raspet, San Francisco, CA (US); Andrew Fuhrer, San Francisco, CA (US); Andrew Brandon, Oakland, CA (US); Hitesh Manglani, San Francisco, CA (US); Emily Heckman, San Francisco, CA (US); Oscar Mota-Huerta, San Francisco, CA (US)

(21) Appl. No.: 18/180,682

(22) Filed: Mar. 8, 2023

Related U.S. Application Data
(60) Provisional application No. 63/317,635, filed on Mar. 8, 2022.

(51) Int. Cl. A23J 3/22; A23J 3/14; A23J 3/28

(52) U.S. Cl. CPC A23J 3/227; A23J 3/14; A23J 3/28

(57) ABSTRACT

Provided herein are methods and wet spinning systems to produce a fiber-spun, chicken-like, food product.

### CROSS REFERNCE TO RELATED APPLICATIONS

The present application claims priority to U.S. Provisional Application Serial No. 63/317,635, filed Mar. 8, 2022, herein incorporated by reference in its entirety.

### BACKGROUND

The invention generally relates to the use of plant-based proteins and polysaccharides, synthesized in the form of wet-spun fibers, for the development of plant-based, chicken-like, food products.

Despite significant efforts, mimicking the fibrous texture of animal meat remains a significant challenge for the plant-based meat industry. The current industry standard is to use extrusion for the texturization of plant proteins. Low moisture extrusion cooking (LMEC) has the benefit of having a high output. It also provides some bite force and mouthfeel. However, this method creates a product with an amorphous structure that does not mimic the unique fibrous texture and appearance of animal muscle tissue. High moisture extrusion cooking (HMEC), with ~50-60% moisture, generates a product with a more uniform and oriented texture. However, while an improvement over LMEC, HMEC is still significantly less fibrous than animal meat. A significant challenge facing the plant-based meat industry has been convincingly mimicking the hallmark muscle-like structures of animal meat using proteins from plants, which lack anything even resembling muscle.

New methods for protein texturization (such as the shear cell technology), or new variations to the HMEC process, or to the process of cutting HMEC slabs, are some of the methods used to bring texture closer to that of chicken products. Alternatively, the use of fermentation technologies, specifically fungal mycelia, for the purpose of improved texture (and at times flavor), is being explored. Finally, cell-based meat technologies have investigated methods for improved and more animal-like flavor. None of these methods have so far been able to mimic the texture of chicken products in a desirable and/or scalable manner. In addition, there are significant scale-up, economics, and at times regulatory challenges associated with some of the methods above.

The present invention attempts to solve these problems, as well as others.

### SUMMARY OF THE INVENTION

Provided herein are methods and wet spinning systems for a fiber-spun, chicken-like, food product. The method of wet-spinning plant fibers, comprises: dissolving plant proteins at a concentration between of about 5% to about 50% with or without polysaccharides; extruding the dissolved plant proteins through a micron-sized spinneret into a coagulation bath containing one or more salts and acids; washing the fibers to remove salt and acid; guiding the fibers through an emulsion bath to apply additional ingredients; collecting the extruded plant fibers on a roller; removing excess water from the product and cutting the collected plant fibers to size to produce a food product; and marinating the product.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1 is a front view of dispersions of 20% wt/wt soy protein isolate with different amounts of urea added. At 1 M, the dispersion was very pasty and thick whereas at 8 M it became very fluid with a viscosity similar to water. 1 M urea is roughly 6% by wt.

FIG. 2A is a schematic of the wet spinning system, according to one embodiment; and FIG. 2B is a schematic of the wet spinning system including a kiss roller, according to one embodiment.

FIG. 3A is a photograph of an industrial mixer to mix the protein dope to create stronger fibers; FIG. 3B is a photograph of a kiss roller to apply flavors, emulsions and/or gelling agents to fibers in line; FIG. 3C is a side view schematic of different geometry configurations of the spinnerets; FIG. 3D is a perspective view of the different spinnerets; FIG. 3E is a schematic view of the island in the sea spinneret that mimics muscle structure: FIG. 3F is a photograph of an in-line sprayer nozzle to spray water on the fibers for in-line washing; FIG. 3G is a photograph of post-coagulation flattening of fibers to increase pick-up of emulsion; and FIG. 3H is a photograph showing the spinneret, coagulation bath, and uptake roller of the wet spinning system, according to one embodiment.

FIG. 4 is a photograph showing the fiber spun from 100% wheat protein isolate (42% total dry wt.) 20, 50% wheat protein/50% soy protein (23.6%) 30, and 10% wheat protein/90% soy protein (16.3%) 40 from 4 M urea dope.

FIG. 5A is a photograph showing fiber-based chicken shreds synthesized from soy protein isolate; and FIG. 5B is a photograph showing chicken meat.

FIGS. 6A-6B are photographs of the fiber-based chicken tenders synthesized from soy protein isolate.

FIGS. 7A-7B are photographs showing fiber-based chicken strips synthesized from soy protein isolate.

FIG. 8A is a photograph of the fiber-spun chicken breast; and FIG. 8B is a photograph of the fiber-spun chicken breast in a cut portion.

FIGS. 9A-9B are microscope images of mung bean fibers (plus 0.5% alginate) under the 20X magnification. FIG. 9C is a microscope image of the chicken breast fibers, showing a diameter of 148.6 µm, Scale bar = 125 µm. FIG. 9D is a microscope image of the fibers made out of a mixture of soy protein isolate and alginate, viewed under the microscope, Scale bar = 125 µm.

FIG. 10 is a graph showing the viscosity vs. shear rate values for a spinning dope consisting of a hydrolyzed plant protein and a polysaccharide.

FIGS. 11A-11D are graphs showing the storage and loss moduli for the soy, mung, pea, and faba spinning dopes.

FIG. 12A is a microscope image of 10% Soy Protein Isolate (SPI) in H₂O; FIG. 12B is a microscope image of 10% SPI in 0.5 M urea; FIG. 12C is a microscope image of 10% SPI in 1 M urea; and FIG. 12D is a microscope image of 10% SPI in 2 M urea, where there was no pH adjustment to the dopes.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and food arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### Description of Embodiments

Generally speaking, the wet spinning method comprises using plant protein isolates or concentrates at a concentration between about 5% to about 50%, with or without polysaccharide(s), for the production of fine protein fibers. In one embodiment, the wet spinning method comprises dissolving plant proteins at high pH (>8), extruding the dissolved plant proteins through a micron-sized spinneret using a metering pump and directing the extruded plant proteins in a coagulation bath at low pH (<4). Then, the extruded plant fibers are collected on a roller and cut to size to produce a plant-based facsimile of a whole-cut chicken meat product e.g., a chicken breast. The wet spinning method comprises small modifications and the use of binders for the development of other chicken-like products that are developed through the use of plant-based materials.

Suitable proteins include proteins of non-animal origins and plant-based proteins. For example, suitable plant-based proteins may include Soy (Concentrate/Isolate), Pea (Concentrate/Isolate), Wheat (Gliadin, Glutenin, Gluten), Lentil, Beans, Corn (Zein), Oat, Barley, Amaranth, Rice, Buckwheat, Farro, Flaxseed, Quinoa, Rye, Sorghum, Teff, Sunflower, and Nuts (Peanuts, Almonds, Pecans). Proteins of algal, fungal, and/or bacterial origin are also suitable. In one embodiment, the plant protein is a hydrolyzed protein isolate, instead of commonly available (i.e. non-hydrolyzed) protein isolate. The hydrolyzed protein isolate provides smaller protein aggregates, needing a milder alkaline pH in the dope. Hydrolyzed protein isolate is made by breaking down large protein molecules into smaller polypeptides. The protein isolates can be hydrolyzed by chemical or enzymatic processes and may be classified according to their degree of hydrolysis.

In one embodiment, the process incorporates a polysaccharide in addition to protein. In one embodiment, at least 0.5% alginate is incorporated with a mung bean protein before spinning. Polysaccharides fibers have higher tensile strength than pure protein fibers, so their inclusion at relatively low levels can aid protein fiber formation and processing.

Polysaccharides are long polymers of individual sugar molecules, typically more than 200 units. In one embodiment, suitable polysaccharides include dextrans. A dextran means a complex, branched polysaccharide comprising multiple glucose molecules joined into chains of varying lengths (e.g, from about 10 to about 150 kDa). The straight chain consists of α1→6 glycosidic linkages between glucose molecules. The branched chain may contain α1→4 linkages, α1→2 linkages and/or α1→3 linkages.

Saccharides (sugar types) suitable for conjugation to proteins or other macromolecules include reducing monosaccharides such as glucose, fructose, glyceraldehyde and galactose. Many disaccharides, like lactose and maltose, also have a reducing form, as one of the two units may have an open-chain form with an aldehyde group. In glucose polymers such as starch and starch-derivatives like glucose syrup, maltodextrin and dextrin the macromolecule begins with a reducing sugar, a free aldehyde. More hydrolyzed starch contains more reducing sugars. The percentage of reducing sugars present in these starch derivatives is called dextrose equivalent (DE).

In some embodiments, the carbohydrates, such as dextrans, have a molecular weight range between about 10 kDa and about 500 kDa. In other embodiments, the dextrans have a molecular weight range between about 40 kDa and about 100 kDa, or between about 70 kDa and about 100 kDa.

Fiber spinning comprises the process of making fibers from (bio)polymers and provides a path for mimicking the texture and appearance of animal muscle fibers. In this process, natural biopolymers are processed in such a way that long thin fibers of polymer material are produced. Said fibers are incorporated into plant-based meat alternative products to enhance textural, visual, and flavor properties such that the end products are more ‘meat-like’ in nature. Natural biopolymers used in the process of fiber making include plant derived polysaccharides (alginate, carrageenan, pectin, methylcellulose, other cellulose derivatives, agar, gellan, and the like), plant-derived proteins (soy, pea, faba, wheat, etc.), or blends thereof. Fibers are formed through a wet-spinning process, whereby selected high molecular weight biopolymers are dispersed in a solvent and made to undergo structural rearrangements such that the long chain polymers unravel and adopt a more linear (less globular) conformation.

Rearrangement in protein structure to facilitate spinning is achieved by altering the solvent ionic strength and/or pH (thus altering protein/water and protein/protein interactions). High pH denatures and increases the solubility of plant proteins, thereby reducing the size of particles in a spinning dope, allowing for spinning without issues such as spinneret clogging. The concentration of protein may be between about 5% and about 25%, between about 6% and about 20%, or between about 7% and about 15%.

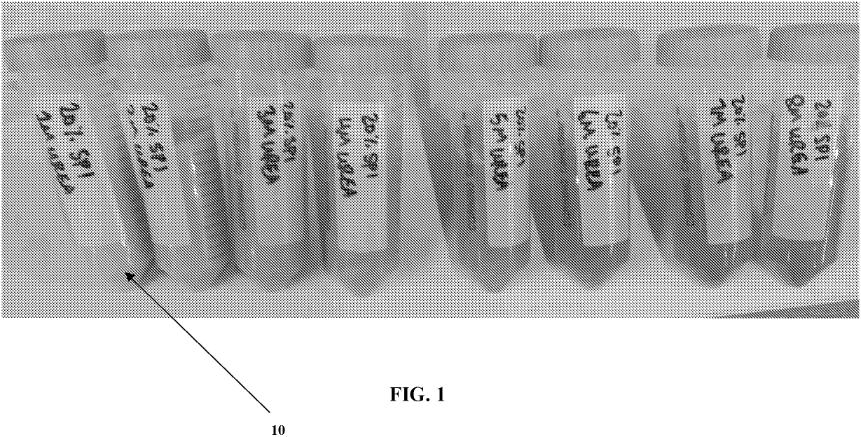

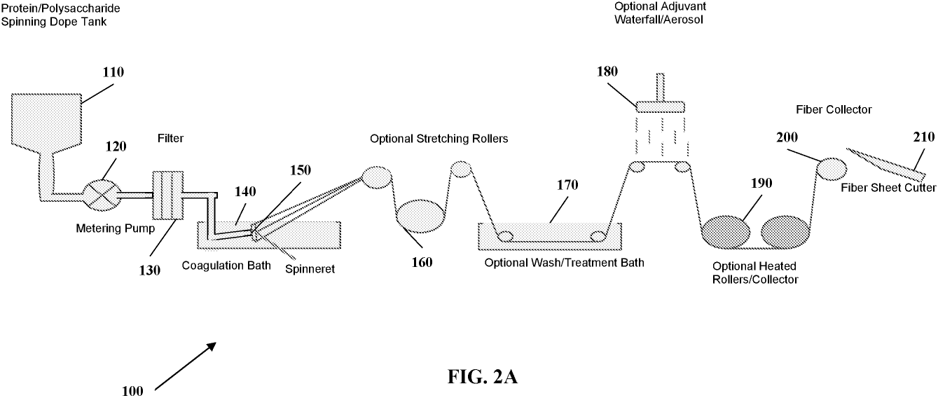

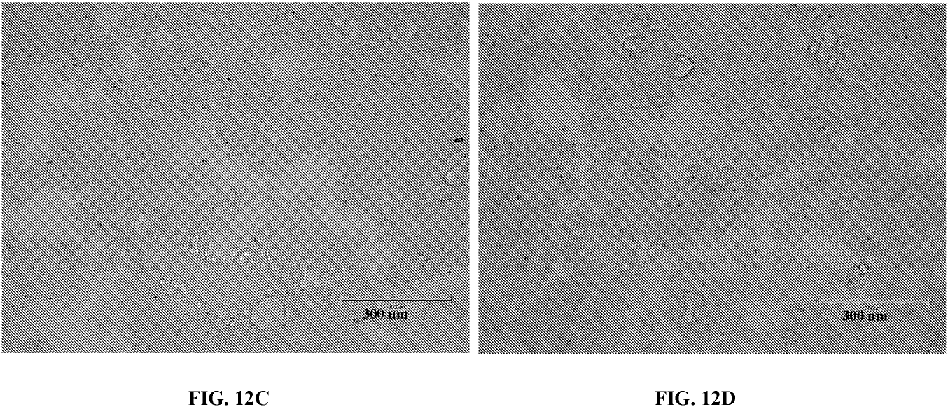

In addition to pH, reducing agents (to diminish polymer cross-linking), denaturing agents (exposing hydrophobic portions of the protein and encouraging intermolecular interactions), heat (to disrupt intra/intermolecular interactions, allowing new ones to form) or a combination thereof, might be used for protein denaturation and increased protein solubility. An example of enhancement in solubility through the use of denaturing agents is depicted in FIG. 1 and FIGS. 12A-12B, where urea has been added to dispersions 10 of about 20% wt/wt soy protein isolate in water. At 1 M urea, the spinning dope is very pasty and thick, whereas increasing urea from 2 M urea to 3 M urea to 4 M urea, to 5 M urea, to 6 M urea, to 7 M urea increasing the fluidity and decreases the viscosity, while at 8 M urea it becomes very fluid with a viscosity of about 10⁻³ Pa. s (Pascal seconds).

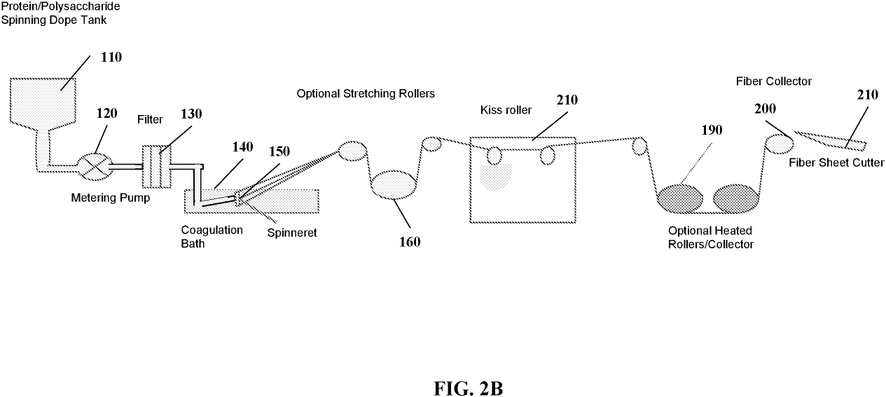

At sufficient protein concentration and solubility and with sufficient structural rearrangement, protein molecules unravel enough to promote significant protein entanglement and the protein solution becomes sufficiently viscous for the wet-spinning system 100, as shown in FIG. 2A. The viscous protein spinning solution is hereby referred to as the ‘spinning dope’. The spinning dope is placed in the spinning dope tank 110 and then metered through a metering pump 120 and a filter 130. The spinning dope is then extruded through small circular dies or spinneret 150 ranging between about 50 µm to about 300 µm in diameter into a coagulating bath 140, where the spinning dope is solidified into a fiber. Shear forces acting on the viscous protein solution during extrusion assist in aligning polymer chains unidirectionally. The coagulating bath 140 is an anti-solvent that alters the protein environment to increase intermolecular interactions as well as physical and/or chemical cross-linking between fibers, causing the solidification of the spinning dope into a fiber as it emerges from the die 150.

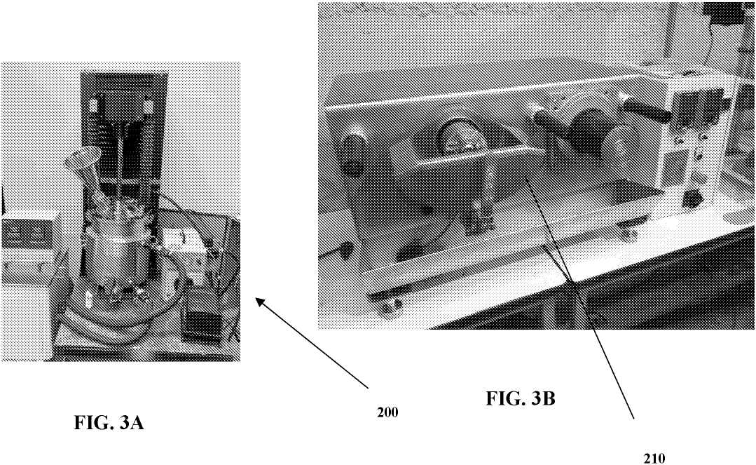

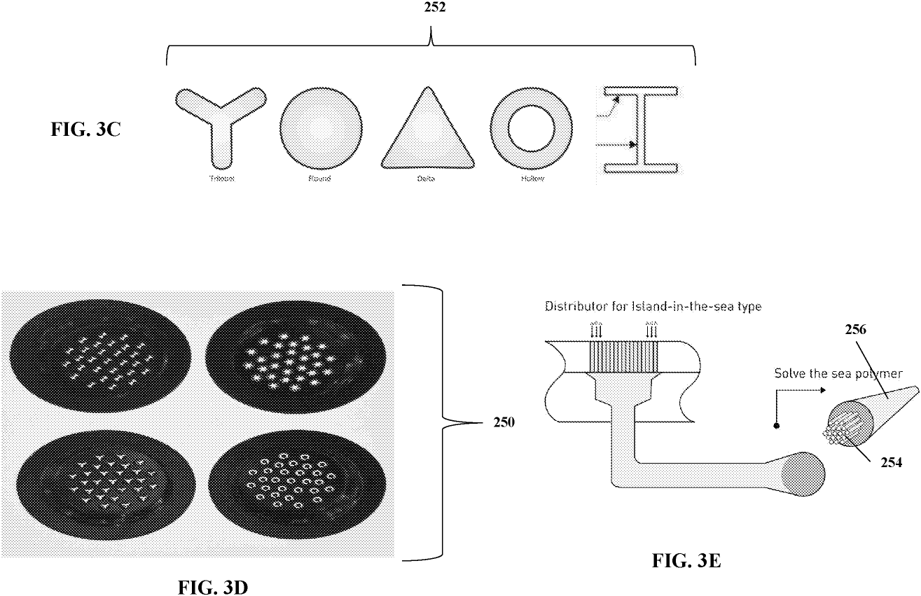

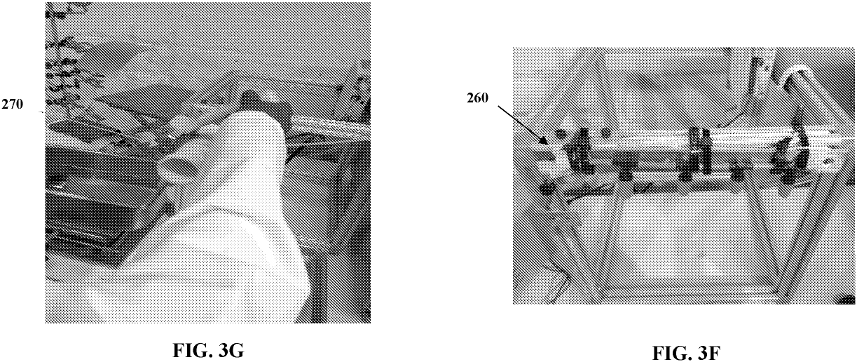

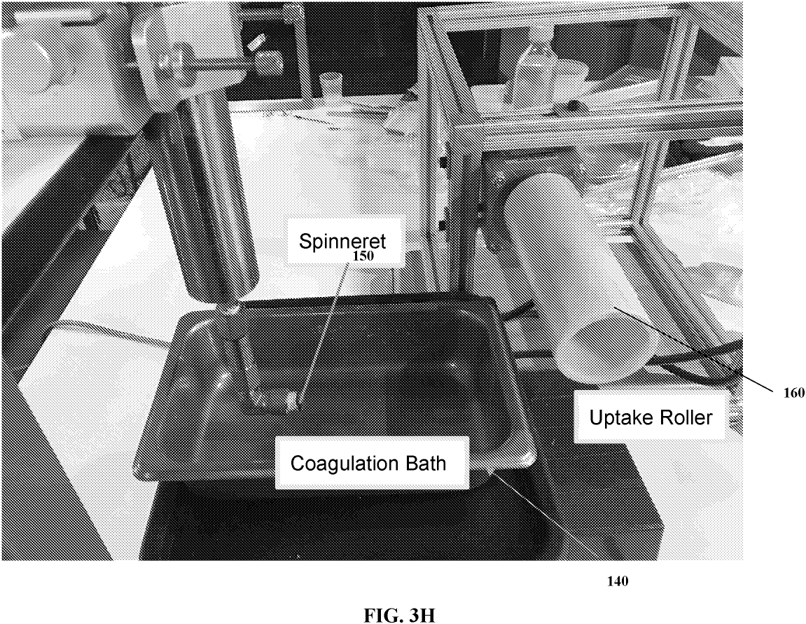

In one embodiment, the use of spinneret dies 250, as shown in FIG. 3D, with different geometric configurations 252, as shown in FIG. 3C, modulate fiber texture, coherence and strength. In one embodiment, an “islands in the sea” style spinneret, as shown in FIG. 3E, modulate fiber texture, coherence and strength to mimic muscle structure. The muscle structure comprises a plurality of fibers 254 bundled into a single fiber 256, as shown in FIG. 3E.

In one embodiment, an industrial mixer for mixing of the protein dope, which is the raw material for forming fibers, in industrial mixers 200, as shown in FIG. 3A. This mixing step achieves strong fibers and may include hydrating the protein, adding the alkaline agent, and degas to remove air bubbles, thus leading to stronger fibers. The rate of mixing (i.e., shear rate of the mixing blades) and time of mixing may be altered accordingly.

Coagulating solvents for proteins and polysaccharides may include mild organic acids (acetic acid, citric acid, lactic acid, dilute hydrochloric acid, tartaric, succinic, malic, phosphoric etc.), dilute strong acids (HCl), ionic salts (NaCl, KCl, CaCl2, etc.), bases (NaOH, KOH, etc.), or combinations thereof. Coagulation bath includes at least one acid and one salt. The solution will be used to produce fibers using the wet spinning system depending on the protein solvent used. For wet spinning, a suitable coagulation bath will be formulated to precipitate the solvents and obtain the fibers. Spinning of the fibers can be carried out at room temperature or at elevated temperatures.

Most suitable temperatures are about twenty-five to eighty-five degrees Celsius. Moreover, the fibers are treated in a coagulation bath for the fibers to precipitate if wet spinning is used. The coagulation bath for wet spinning is composed of acids, alkalis, salts and other chemicals depending on the solvent system used. Examples of acids used include, but are not limited to sulfuric acid, hydrochloric acid and formic acid. Examples of salts used include sodium chloride, sodium sulfate, ammonium sulfate, and aluminum sulfate. The temperature of the coagulation bath could be between approximately zero and one hundred degrees Celsius, preferably between approximately twenty and fifty degrees Celsius.

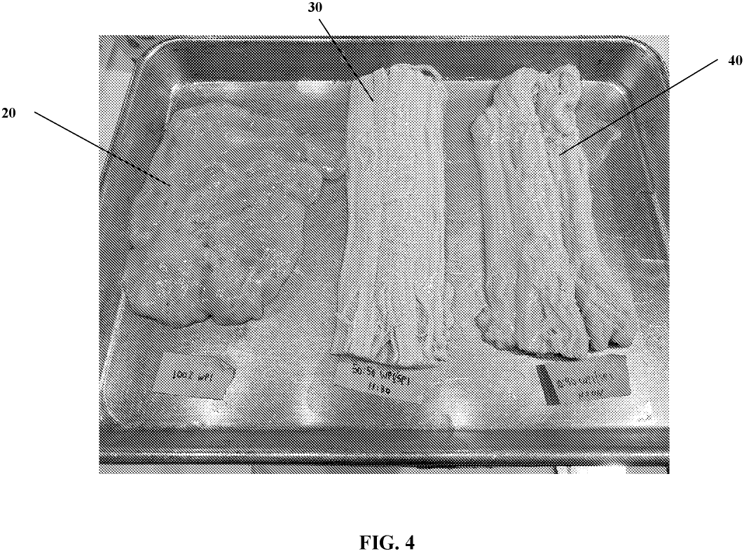

In an additional embodiment, wheat proteins may be used as a blend to produce bicomponent or multicomponent fibers using the wet spinning system. Wheat proteins tend to fuse the fibers together and reduce ‘hairiness’ in the fiber prototypes. An example of the use of wheat proteins to fuse fibers can be found in FIG. 4, where the presence of as little as 10% wheat protein isolate starts fusing fibers made of soy protein isolate. This effect is enhanced by increasing the concentration of wheat protein. If the spinning is composed of only wheat protein isolate (i.e. 100% wheat protein, no soy protein), fibers can be made by wet spinning, but are then fused back together.

As shown in FIG. 2A, the solidified fiber is picked up and drawn through the coagulation bath 150 onto rollers 160, which serve to draw and stretch the fiber, further increasing unidirectional polymer chain alignment/crystallinity. The length of the coagulation bath can be varied (from approximately 6 inches to 6 ft.) to alter the degree of coagulation. The extrusion and rolling speeds can be altered to control spinning dope swelling at spinneret, polymer alignment in fiber, and fiber diameter. Linear velocity at the roller may range from about 5 meters/min to about 1000 meters/min, alternatively from about 1 meter/min to about 2000 meters/min and velocity at each hole in the spinneret may range from about 1 meters/min to about 20 meters/min. The draw ratio, or the ratio of the linear velocity of the first roller and the velocity of extrusion, may range from about 1:1 up to about 40:1.

In one embodiment, a kiss roller 210 is used to apply flavors, emulsions and/or gelling agents to fibers in line, as shown in FIGS. 3B and 2B. A range of material that can be used with the kiss roller. These components could include protein isolates such as wheat, faba bean or hemp seed. These could also include polysaccharides such as konjac glucomannan, xanthan, pullulan, methylcellulose, and various native, modified, and hydrolyzed starches. Additionally, these could include food-grade chemical additives such as polyvinyl alcohol, cetyl alcohol, propylene glycol and/or polyvinylpyrrolidone.

In one embodiment, an in-line sprayer nozzle 260 to spray water on the fibers for in-line washing is used, as shown in FIG. 3F. In other embodiments, methods to accomplish in-line washing step include a secondary water bath, after the coagulation bath, which can help wash off some of the acidity of the fibers. For a fiber system consisting of soy protein isolate and alginate (85:15), the pH without a wash bath is about 4.18, while the pH with a wash bath is about 4.71. In one embodiment, post-coagulation flattening of fibers 270 removes excess water and increases pick-up of emulsion, as shown in FIG. 2G. The post-coagulation flattening of fibers may include a pressure between about 1 lb/in² and about 10 lb/in². In one embodiment, a centrifuge is used for centrifugal drying at speeds of up to 3200 rpm for about 1-5 minutes and compaction of fibers after collection. The weight loss after centrifugal drying includes an average +/- standard deviation of about 47.78% +/- 0.05% (n=25). These dryness numbers depend on the type, rotation speed, and time of centrifuge, in-line drying steps, as well as the composition of fibers and emulsions, and may be different for other centrifugal drying systems.

FIG. 4 is a photograph for the fiber spun 20 from 100% wheat protein isolate (42% total dry wt), the fiber spun 30 from 50% wheat protein/50% soy protein (23.6%), and the fiber spun 40 from 10% wheat protein/90% soy protein (16.3%) from 4 M urea dope.

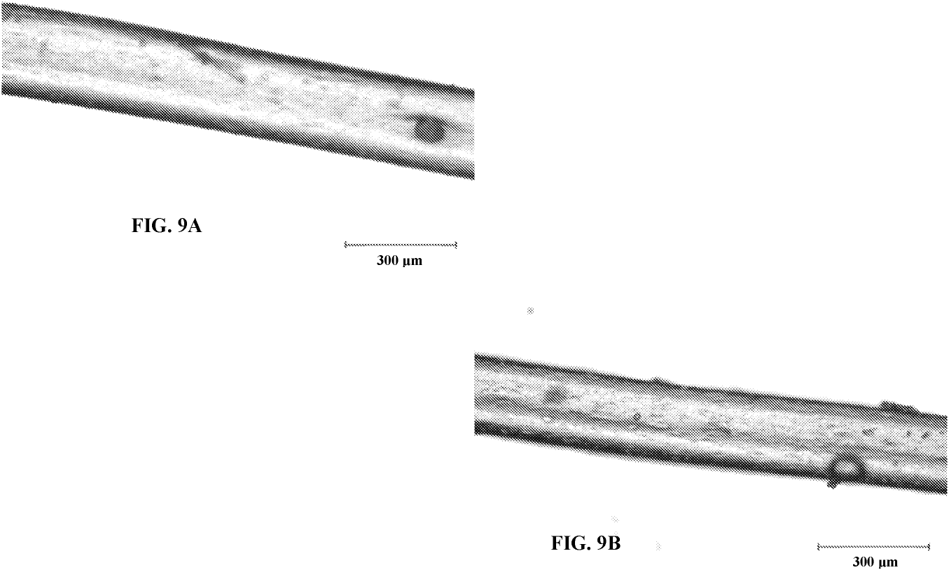

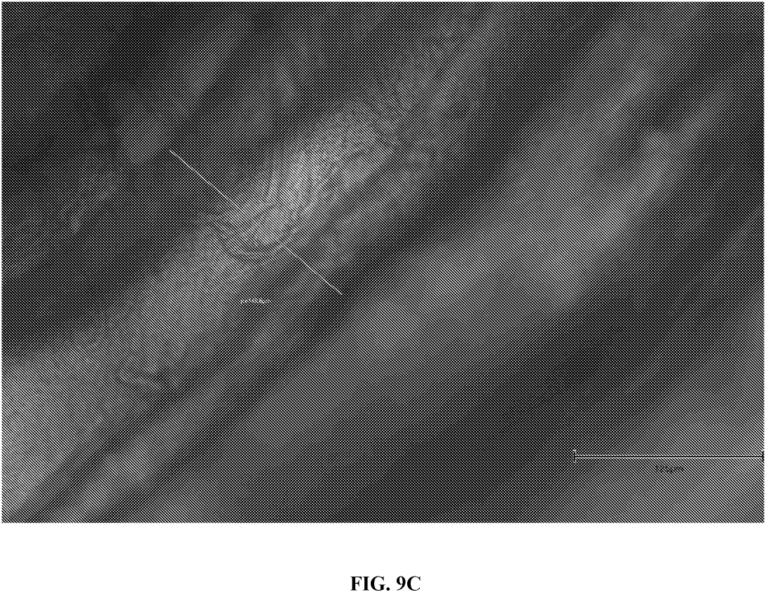

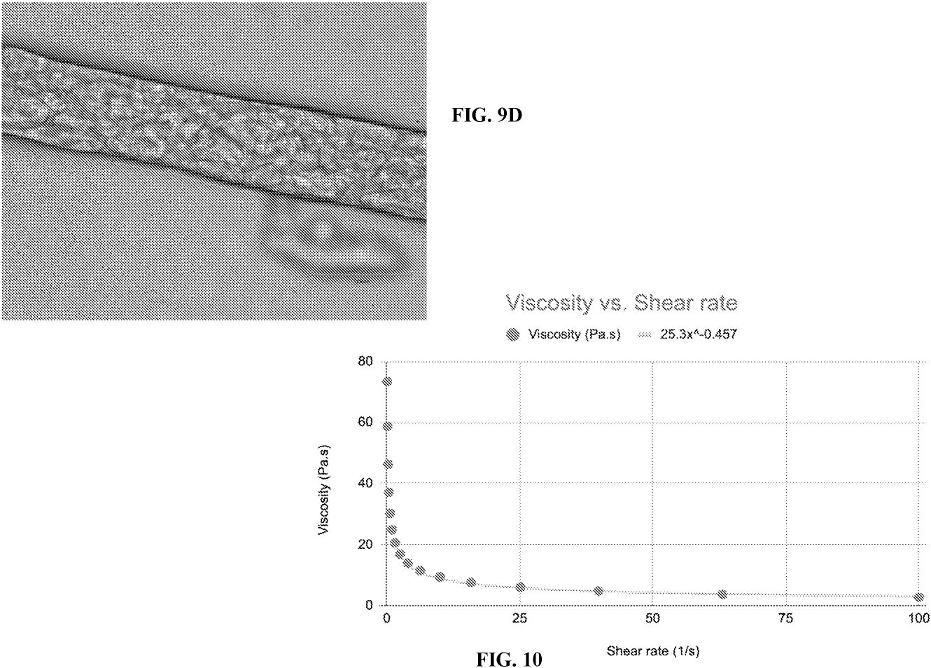

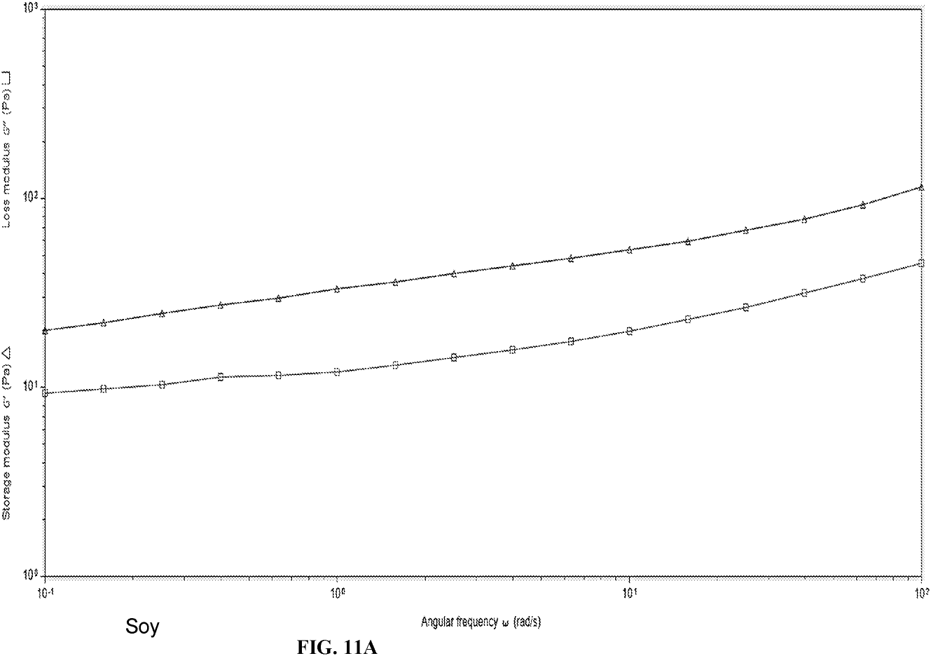

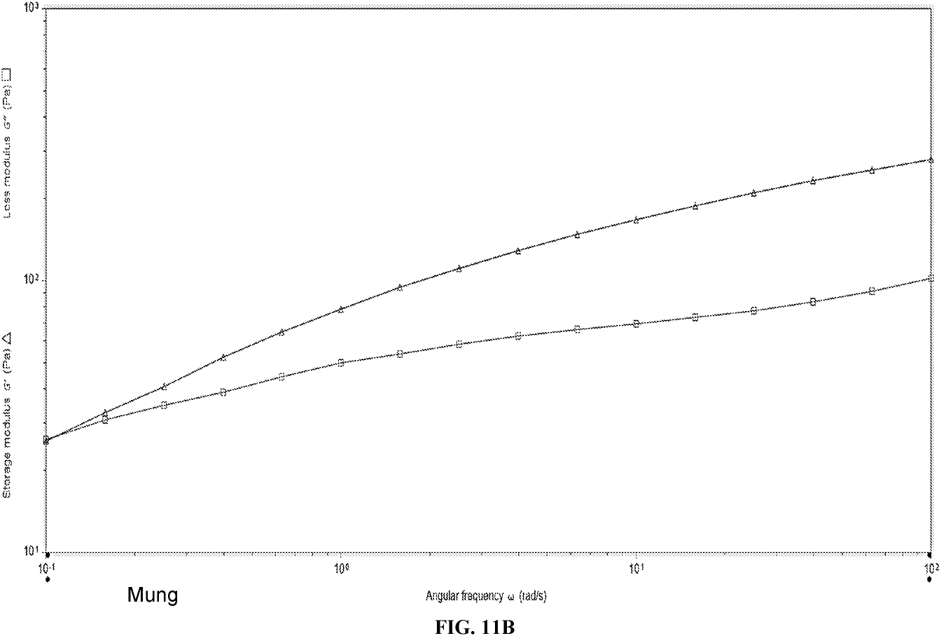

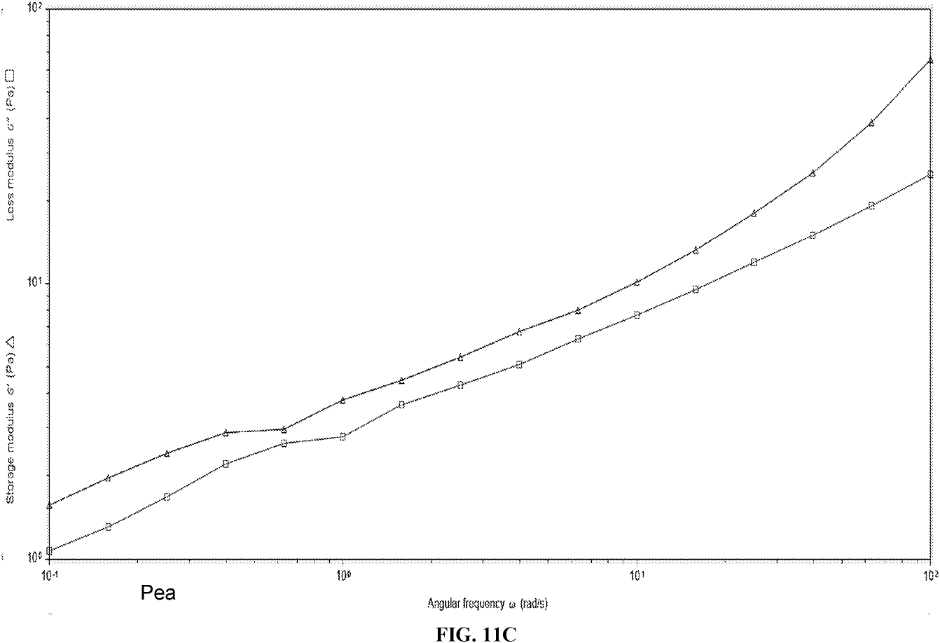

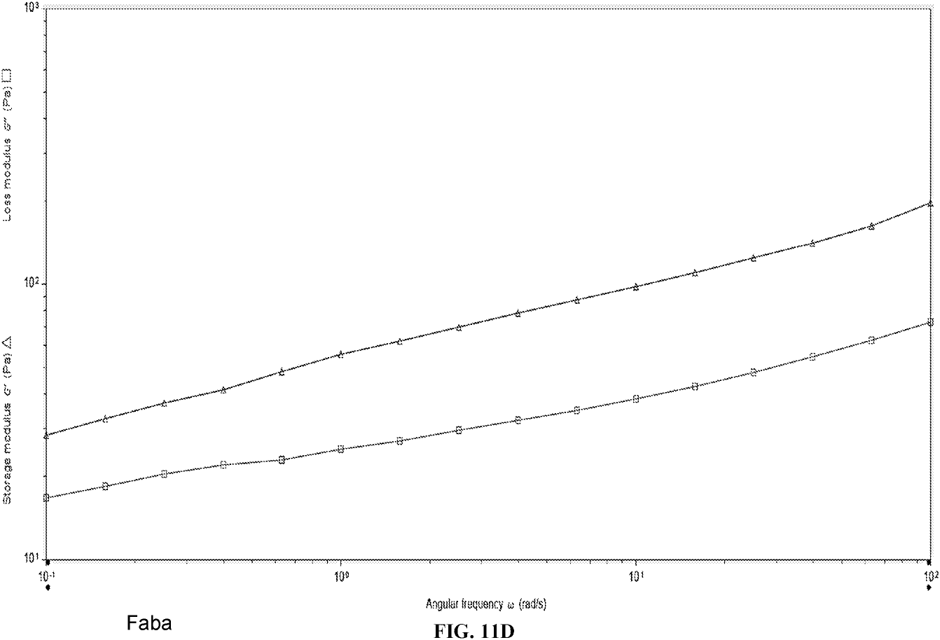

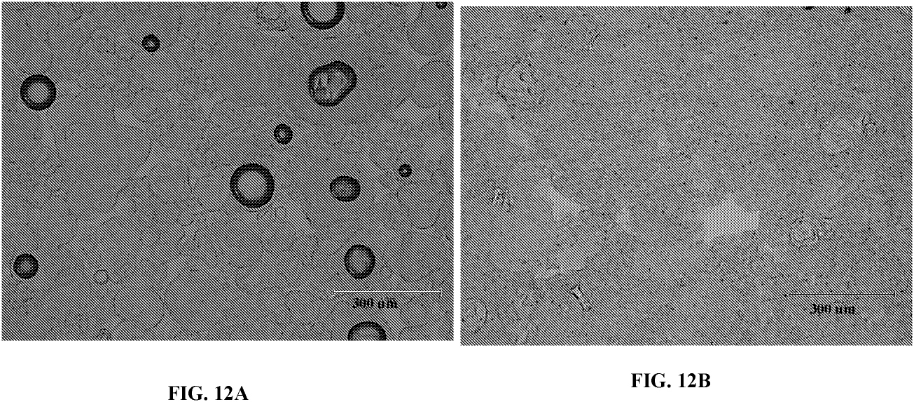

Images of mung bean fibers (plus 0.5% alginate) under the microscope are shown in FIGS. 9A-9B. FIG. 9C is a microscope image of the chicken breast fibers, showing a diameter of about 148.6 µm. Spun fiber can be drawn into consecutive baths 170 for washing and/or additional treatment 180. Treatments 180 may include dragging fibers through pH altering baths, salt baths, baths containing selected adjuvant materials (fats, oils, emulsions, etc.), or baths containing cross-linking agents. Treatment can additionally be applied to fibers by dripping liquids onto rollers, spraying fibers with liquid through a nozzle, submerging fiber collecting rollers into baths, or cutting fibers from rollers and treating them in post-collection baths. Lastly, fibers can be collected on heated rollers 190 for the purpose of drying and increasing fiber strength.

The wet spinning system described herein, creates a novel, muscle-like texture that the plant-based meat industry is currently lacking. The texture created through wet-spinning does not involve the use of mammalian or fungal cells and thus negates the possibility of contamination. Fiber spinning is also faster and more scalable than growing cell-based meat and potentially mycelia. In addition, wet spinning provides significant production flexibility, as any plant protein with the capability to form a viscous dope can be spun using wet spinning, and thus there is less concern for allergenicity. Finally, fibers made using this method do not require sophisticated cutting, such as that required in the case of HMEC, while providing better texture.

In addition to the advantages noted above, the present invention generates fibrous, chicken-like texture that mimics cooked muscle fibers. The cohesion of fibers generated using this method allows for a closer mimic of cooked animal meat, while individual fibers better mimic the sensory experience of eating animal meat. This technology could be used for creating products such as chicken shreds, as discussed herein, or whole muscle cuts such as chicken breast.

Plant based meat-alternatives with incorporated fibers show improved visual, textural, and flavor characteristics and more closely resemble real meat than do products lacking fibers. Aligned fibers can be used as the basis for a whole-muscle plant-based meat product, such as chicken breast. Fibers have high tensile strength relative to their diameter and high-water holding capacity (an important parameter for mouthfeel). The mechanical properties of fibers result in more satisfying and meat-like chew/mouthfeel. Additionally, fibers can act as surfaces for molecules to adhere to and can serve as the matrix or structural scaffold for a larger plant-based meat-alternative product. Fibers can easily be spun into large sheets and layered one on top of another. Additional materials (fat, emulsions, spices, flavorings, etc.) can be applied during the fiber spinning process or after collection is complete. Depending on fiber material processing, fibers can become tightly bound to one another and the stringiness/bulk density of the meat-like product can be controlled. Color and flavor molecules can be co-mixed with fiber forming polymer into the spinning dope, and thus be incorporated directly into fibers. The fiber diameter depends on several parameters including spinneret hole diameter, collection speed, and draw ratio. In one embodiment, spinning soy protein through a 300 µm spinneret leads to a fiber diameter between 10 µm and 1,000 µm. The tensile strength is between about 0.01 g/tex to about 0.2 g/tex and they have an elongation at break ranging from about 10% to about 35%. The diameter of the spinneret may be between 50 µm and about 1000 µm.

In one embodiment, wet-spun fibers are made from protein sources, whereas polysaccharides are added to enhance spinnability or texture. Fibers formed from proteins have more desirable texture and greater nutritional value. Spinning dopes are prepared by dissolving plant protein isolates in water and adjusting the pH. Examples of plant proteins include, but are not limited to soy, pea, faba, mung bean protein, and mixtures thereof. Proteins are dispersed in water at concentrations ranging from about 5 wt. % - about 50 wt. % of the solution, alternatively, from about 6 wt.% to about 40 wt. % of the solution, alternatively, between about 7 wt.% to about 30 wt. % of the solution. The pH of the spinning dope is then adjusted with NaOH or KOH to the range of about 10 to about 13, to solubilize and reduce the size of protein particles. The resulting dopes are shear thinning fluids, with increased shear rate resulting in reduced viscosity FIG. 10.

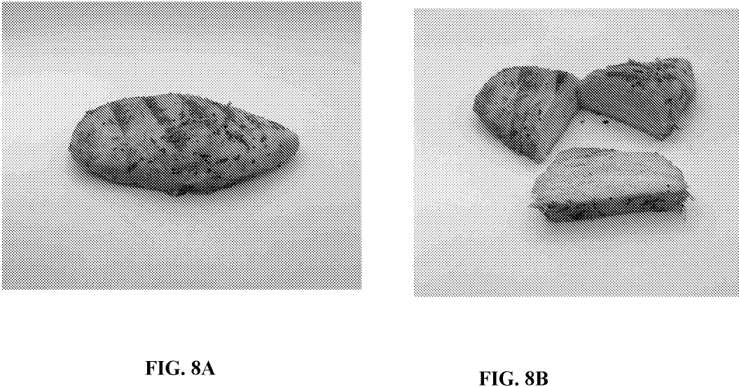

All dopes are viscoelastic and show varying storage and loss moduli. However, storage and loss moduli in the dope do not necessarily correlate with properties of the fibers formed from said dope. For example, spinning dopes composed of the faba bean protein isolate or show a storage modulus of about 198 Pa at an angular frequency of about 100 rad/s, which is significantly higher than the storage modulus of soy protein isolate at the same angular frequency (about 115 Pa). However, fibers made out of soy protein isolate have higher tensile strength, as shown in the storage and loss moduli graphs in FIGS. 8A-8D. A similar observation can be made about dopes made with mung bean protein isolate. These dopes have a storage modulus value that is double the value of soy protein isolate but are weaker. On the other hand, spinning dopes from pea protein isolate show a storage modulus of about 65 Pa at an angular frequency of about 100 rad/s, which is less than the value observed for soy and are also weaker fibers compared to soy fibers.

Viscosity is an important parameter for efficient spinning. When viscosity is too high, spinnability is negatively impacted. For example, a high viscosity dope is more difficult to mix, leaving some protein insufficiently hydrated/dispersed. Viscosity may be measured by any suitable method using any suitable viscometers and rheometers such as, but not limited to, a Brookfield Viscometer. Generally, the viscosity should be along a desired flow curve and is not limited to any single value.

Spinning dope is extruded through dies into coagulant to form solid fibers. The number of holes in each die (and thus number of fibers formed) may vary from about 1 to about 5,000 holes; and the hole diameter may vary from about 50 µm to about 300 µm, alternatively between about 10 µm to about 1,000 µm). Depending on spinning dope swelling behavior at the spinneret and the drawing speed, and drawing ratio resultant fiber diameter will vary. Fibers may be spun into coagulation baths consisting of acetic acid, citric acid, or lactic acid, hydrochloric acid. etc., with resultant bath pH ranging from about 1 to about 3.5. Coagulating baths may contain NaCl, KCl, CaCl₂ or mixtures thereof, in concentrations ranging from about 5 wt. % to about 20 wt. % of total solution. Fibers may be drawn into secondary wash baths containing water or dilute alkali to adjust pH and are then drawn onto rollers heated at a range of temperatures (room temperature to about 120 C) and then cut off into sheets. The water content of fibers may be as high as about 90% by mass. Fibers may be post-treated with additional wash baths containing either water, dilute salt (up to ~5 wt.%), or cross linkers (e.g. ~1%-2% transglutaminase).

If deemed necessary for texture or spinnability, polysaccharides can be added to proteinaceous spinning dopes. Polysaccharides that do not degrade under spinning conditions and that gel/coagulate under conditions compatible with protein fiber coagulation are selected (namely polysaccharides that gel in acidic conditions or in presence of ionic salts, such as alginate, carrageenan, pectin, methylcellulose, other cellulose derivatives, agar, and gellan) are added at concentrations ranging from 0.5 wt. % to about 5 wt. %.

The wet spinning system can be practiced with a wide array of compositions. The compositions of the spinning dope may be changed by using a variety of plant proteins and polysaccharides, to generate new fiber compositions that could have different mouthfeel or strength.

In another embodiment, the final product may generate whole muscle-like products, such as chicken breast. In such embodiment, the bundle fibers would be cut, and binders utilized, such as emulsions made from water, oil, methylcellulose, and proteins/starches/gums to develop a whole muscle product. A similar embodiment could develop other whole muscle products, such as chicken thighs, and other plant-based meat products.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers (e.g., amounts, temperature, etc.), but some errors and deviations should be accounted for. Unless indicated otherwise, parts are parts by weight, temperature is in °C or is at ambient temperature, and pressure is at or near atmospheric.

### Example 1: Chicken Shreds

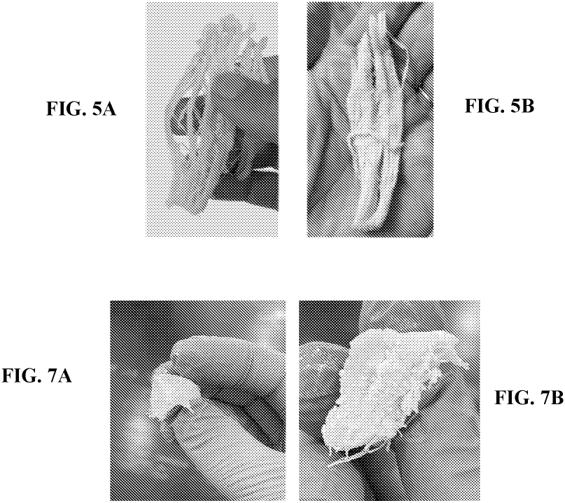

Chicken shreds were formed by the above embodiments of the wet spinning system to form a food product, as shown in FIG. 5A. As spun or crosslinked fibers may be used as chicken shreds products, as shown in FIG. 5A. A comparison chicken shred is shown in FIG. 5B.

### Example 2: Chicken Strips

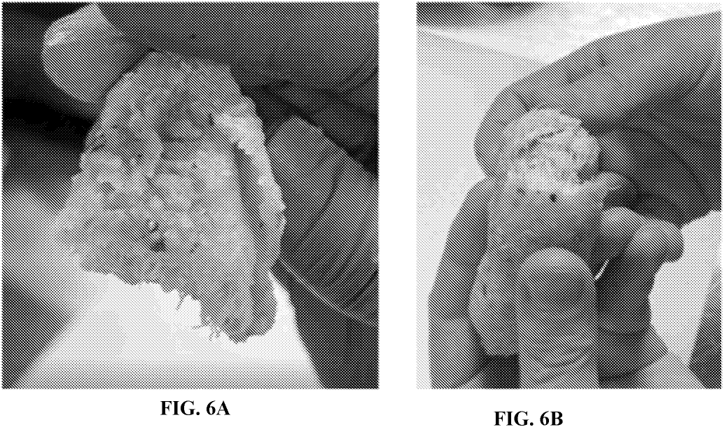

Chicken strips produced by the above embodiments of the wet spinning system is shown in FIGS. 7A-7B. And an oil in water emulsion, containing starch and methylcellulose is used to make the chicken strips. Chicken strips are FIG. 7. Chicken tenders are FIG. 6.

### Example 3: Chicken Tenders

Chicken tenders produced by the above embodiments of the wet spinning system are shown in FIGS. 6A-6B.

### Example 4: Chicken Breast

Example of a plant-based chicken breast using wet-spun fibers of the above embodiments, which have been exposed to emulsions in-line, and dried and marinated is shown in FIGS. 8A-8B.

### Example 5: Spinning Dope with Urea

FIG. 12A is a microscope image of 10% SPI in H₂O; FIG. 12B is a microscope image of 10% SPI in 0.5 M urea; FIG. 12C is a microscope image of 10% SPI in 1 M urea; and FIG. 12D is a microscope image of 10% SPI in 2 M urea, where there was no pH adjustment to the dopes. There are some large bubbles in FIG. 12A, but the proteins in the dope are shown as aggregates. Urea is used to denature the proteins in the spinning dope, thereby reducing their particle size and viscosity and make them flowable. This is normally done by increasing the pH of the spinning dope, so urea is another way to make the spinning dope.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method of wet-spinning plant fibers to create a food product, comprising:
dissolving plant proteins at a concentration between of about 5% to about 50%;
extruding the dissolved plant proteins through a spinneret sized between 10 microns and 1000 microns;
directing the extruded plant proteins in a coagulation bath at a pH less than 7;
rolling the extruded plant fibers on a roller; and
cutting or molding the rolled extruded plant fibers to size to produce a food product.

2. The method of claim 1, wherein the dissolved plant proteins undergo structural rearrangements such that the long chain polymers unravel and adopt a more linear conformation and either increasing or decreasing protein interactions, altering the solvent ionic strength and the pH and altering protein/water and protein/protein interactions through the use of reducing agents, denaturing agents, pH adjustment, and through the use of heat to disrupt intra/intermolecular interactions, or through a combination thereof.

3. The method of claim 2, further comprising dissolving plant proteins with a polysaccharide, wherein the polysaccharide is selected from the group consisting of alginate, carrageenan, pectin, amidated pectin, methylcellulose, other cellulose derivatives, agar, pullulan, gellan, and other microbially-expressed polysaccharides; and wherein the plant proteins are selected from the group consisting of soy, pea, faba, wheat, hemp, canola, mung, other seed storage proteins, animal proteins microbially-expressed, or blends thereof.

4. The method of claim 3, further comprising fusing the plant fibers with gluten protein or other more soluble proteins.

5. A method of wet-spinning plant fibers to produce a food product, comprising:
dissolving plant proteins at a concentration between of about 5 % to about 50% and a denaturing agent such as urea to unravel long chain polymers of the plant protein and reduce the plant proteins particle size;
extruding the dissolved plant proteins through a spinneret sized between 10 microns and 1000 microns;
directing the extruded plant proteins in a coagulation bath;
rolling the extruded plant fibers on a roller;
and cutting or molding the rolled extruded plant fibers to size to produce a food product.

6. The method of claim 5, further comprising dissolving plant proteins with a polysaccharide, wherein the polysaccharide is selected from the group consisting of alginate, carrageenan, pectin, amidated pectin, methylcellulose, other cellulose derivatives, agar, pullulan, gellan, and other microbially-expressed polysaccharides; and the plant proteins are selected from the group consisting of soy, pea, faba, wheat, hemp, canola, mung, other seed storage proteins, animal proteins microbially-expressed, or blends thereof.

7. A wet-spinning system comprising:
Placing a viscous protein or protein/polysaccharide dope in a tank;
Extruding the spinning dope through a plurality of dies, wherein the plurality of dies include a diameter between about 10 µm to about 1000 µm; and
Extruding the dope into a coagulation bath, causing it to form multiple fibers.

8. The system of claim 7, wherein the coagulating bath includes a solvent that alters the polymer environment to increase intermolecular interactions and chemical cross-linking between fibers, causing the solidification of the spinning dope into a fiber as it emerges from the plurality of dies.

9. The system of claim 7, wherein the solvent includes mild acids selected from the group consisting of acetic acid, citric acid, lactic acid, dilute hydrochloric acid, tartaric acid, succinic acid, malic acid, and phosphoric acid, ionic salts selected from the group consisting of calcium, potassium, sodium, magnesium, or other alkali salts, and other derivates or combinations thereof.

10. The system of claim 7, further comprising drawing the solidified fiber from the coagulation bath onto rollers, and stretching the fibers to increase unidirectional polymer chain alignment/crystallinity and tensile strength.

11. The system of claim 10, wherein the length of the coagulation bath is varied to alter the degree of coagulation.

12. The system of claim 11, further comprising altering the extrusion and rolling speeds to control spinning dope swelling at spinneret, polymer alignment in fiber, and fiber diameter.

13. The system of claim 12, further comprising drawing the spun fiber into consecutive baths for washing or additional treatments.

14. The system of claim 13, wherein the additional treatments include dragging fibers through pH altering baths, salt baths, baths containing selected adjuvant materials or baths containing cross-linking agents, dripping liquids onto rollers, spraying fibers with aerosol, submerging fiber collecting rollers into baths, or cutting fibers from rollers and treating them in post-spinning wash baths.

15. The system of claim 14, wherein further comprising collecting and drying the fibers on heated rollers.

16. The system of claim 14, wherein the spinneret die is an islands-in-the-sea style spinneret to spin the fibers in a configuration similar to that of muscle fiber.

17. The system of claim 16, further comprising a kiss roller used to apply flavors, emulsions and/or gelling agents to fibers in line, such as utilizing wheat proteins to fuse the fibers together and reduce fraying of the fibers; using the kiss roller to apply polysaccharides such as konjac glucomannan, xanthan, pullulan, methylcellulose, and various native, modified, and hydrolyzed starches, wherein the food-grade chemical additives such as polyvinyl alcohol, cetyl alcohol, propylene glycol and/or polyvinylpyrrolidone this is an incomplete sentence; and using a pump/syringe to apply emulsions on the fibers as the fibers are being wound.

18. The System of claim 17, further comprising an in-line sprayer nozzle to spray water on the fibers for in-line washing to increase the pH as compared to without in-line washing.

19. The system of claim 18, further comprising post-coagulation flattening of fibers or fiber bundle to increase the pick-up of an emulsion.

20. The system of claim 19, further comprising a centrifuge for centrifugal drying of the fibers for compaction of fibers after collection.
